(19) United States
(12) Patent Application Publication
(10) Pub. No.: US 2012/0061488 A1
(43) Pub. Date: Mar. 15, 2012

(54) Hands-Free Directable Low-Pressure Air Source and Method for Cosmetology Use

(76) Inventor: Maria A. NAVARRO, Houston, TX (US)

(21) Appl. No.: 13/302,132

(22) Filed: Nov. 22, 2011

Related U.S. Application Data
(63) Continuation of application No. 12/240,116, filed on Sep. 29, 2008, now Pat. No. 8,087,594.
(60) Provisional application No. 60/976,421, filed on Sep. 29, 2007.

(51) Int. Cl. B05B 9/08; A62B 18/00

(52) U.S. Cl. 239/153; 239/270

(57) ABSTRACT

Disclosed is a low-pressure air source that provides directional control over a low-pressure airflow. The air source is specifically adapted for use in the application of artificial eyelash extensions to a person's individual eyelashes. An air pump provides low pressure air to an airflow nozzle mounted on the finger of the user. A foot control operates the air pump. The finger nozzle allows the user to direct the airflow without having to grasp the nozzle with the fingers. This allows the user's hands to be free to perform other manual manipulations during the process of adhering artificial lash extensions to a person's individual natural eyelashes.

This application claims priority benefit of pending U.S. patent application Ser. No. 12/040,116 filed 29 Sep. 2008, to which the present application is a Continuation application, and to U.S. Provisional Application Ser. No. 60/976,421 filed 29 Sep. 2007 (now expired).

### FIELD OF THE INVENTION

The present invention is in the field of cosmetic materials and the education and demonstration of their proper use. More specifically, the present invention relates to personal grooming and artificial eyelashes adapted for attachment on hair growing from an eyelid, and apparatuses and methods specifically adapted for use in the application of artificial eyelash extensions to individual natural eyelashes.

### BACKGROUND OF THE INVENTION

Applying eyelash extensions is a labor-intensive procedure that requires a high level of manual dexterity. An eyelash extension in the context of the present invention consists of an artificial lash hair extension attached to an individual natural eyelash of a human subject. An extension may be of human, animal, or synthetic origin. To apply the lash extensions, practitioners (e.g., beauticians and cosmetologists) commonly use surgical instruments such as tweezers and forceps, and the application process requires precision as well as manual dexterity in the use of these instruments, typically using the index finger and thumb of the beautician's favored or dominant hand.

The beautician will first select an individual lash extension from a cache of extensions, then apply an adhesive near the base of the lash extension, and next apply the lash extension with adhesive, to an individual natural eyelash of the subject, which natural eyelash has been individually selected and isolated from surrounding eyelashes. An adhesive is utilized as a means to attach the extension to the user's natural eyelash. The adhesive consists of a fluid that sets over a short but variable period of time, which typically is in the order of 60 seconds or more. A significant amount of the time incurred during the application of the lash extensions consists of waiting for the adhesive to set and cure. Further, the beautician must separate the particular eyelash receiving the extension from surrounding eyelashes, as “spoils” from the adhesive can cause adjoining eyelashes to bond together or unsightly and painful clumps of cured adhesive. Finally, working in close proximity to a subject's eye with the instruments requires slow and methodical movements of the beautician's hands, further increasing the time required to apply a full set of lash extensions. A typical application of a complete set of lash extensions can take an experience beautician two hours. Beauticians with less dexterity or experience typically take longer.

An object of the present invention is to provide a means for separating an individual eyelash of a user from surrounding eyelashes utilizing an airflow. Another object of the present invention is to provide a source of low pressure, directable and airflow for use to accelerate the setting time of the adhesive. A further and highly useful object of the present invention is to provide a substantially “hands-free” low pressure, directable airflow source, that allows application of lash extensions without the practitioner having to put down the instruments being used in order to operate and direct the air flow source. A feature of the present invention is that useful additives can be added to the air flow for functional or aesthetic benefits.

### BRIEF DESCRIPTION OF THE DRAWINGS

FIG. 1 is a component diagram showing the primary components of the present hands-free, directable low-pressure air source.

FIG. 2 is a schematic diagram of the air dispensing unit of the hands-free, directable low-pressure air source.

FIG. 3 is a schematic diagram illustrating the air dispensing unit of the hands-free, directable low-pressure air source mounted on the index finger of a beautician.

FIG. 4 is a schematic diagram illustrating use of a hook and loop strap mount as an alternative mount for attaching the air dispensing unit to a (gloved) finger.

FIG. 5 is a partial cross-sectional diagram of the nozzle end of the air dispensing unit showing a laterally pivotable ball-and-socket joint connecting the air nozzle to the barrel of the air dispensing unit.

FIG. 6 is a component diagram showing alternative embodiments of the primary components of the present hands-free, directable low-pressure air source.

FIGS. 7A and 7B are schematic diagrams of a practitioner's hand (A) in an open configuration and having the nozzle of the present invention mounted on a finger of the hand, and (B) with the index finger and thumb in the working position incorporating the present invention on the ring finger.

FIGS. 8A and 8B are cross-sectional views of alternative embodiments of the barrel portion of the air dispenser of the present invention.

### DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

The present invention relates to an apparatus and method specifically adapted for use in the application of a single artificial lash extension to a person's individual natural eyelash. The apparatus is a remotely controlled, hands-free, low-pressure air source having a directable air flow nozzle. The method relates to the use of the remotely controlled, hands-free, low-pressure air source for cosmetology use to substantially reduce the time previously required to apply a full set of individual lash extensions to a subject's natural eyelashes. The combination of the apparatus and method of the present invention substantially reduces the amount of time necessary to apply a full set of such individual lash extensions relative to what is currently required in the industry. Note that although the apparatus and method may be described herein for a right-handed beauty practitioner, it is intended and anticipated that the appropriate left-handed description is easily inferred from these teachings for the left-handed practitioner.

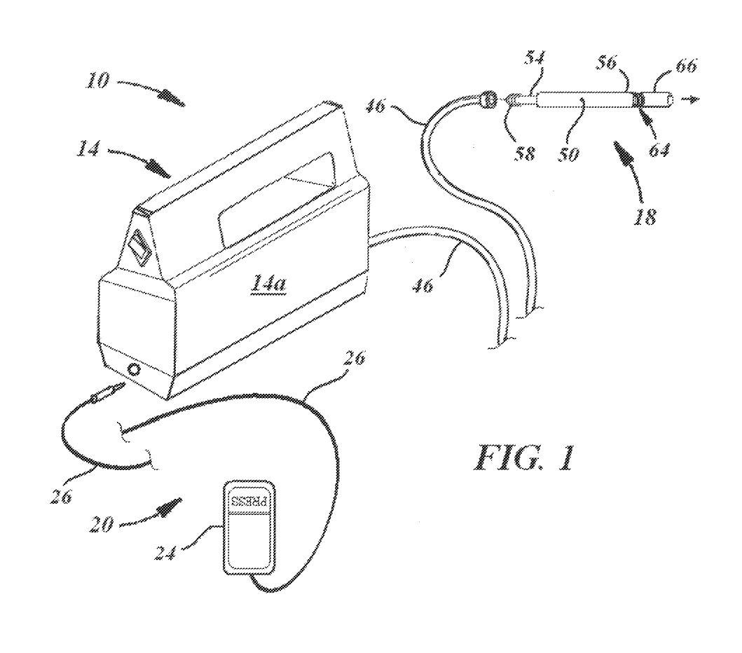

As illustrated in FIG. 1, the present hands-free, directable low-pressure air source 10 for cosmetology use comprises: a low-pressure air flow source 14, a remote control unit 20, an air dispensing unit 18 and the appropriate tubing and cabling to interconnect these components. The present air source 10 is “hands-free” in that a beautician using the apparatus does not have to use any of his/her dexterity to operate the apparatus. More specifically, a practitioner does not have to use any of his/her fingers to hold the air dispenser 18 component of the air source 10, or to control the flow of air from the dispenser 18. The air source 10 is “directable in that the air nozzle fitting 66 of the air dispenser 18 may be variably positioned relative to the barrel 50 of the air dispenser 18 to alter the direction of the air flow expelled from the nozzle orifice 68 of the air nozzle 66.

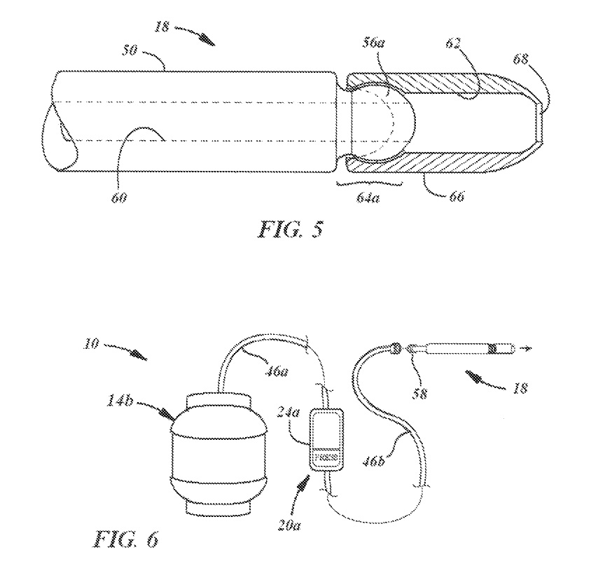

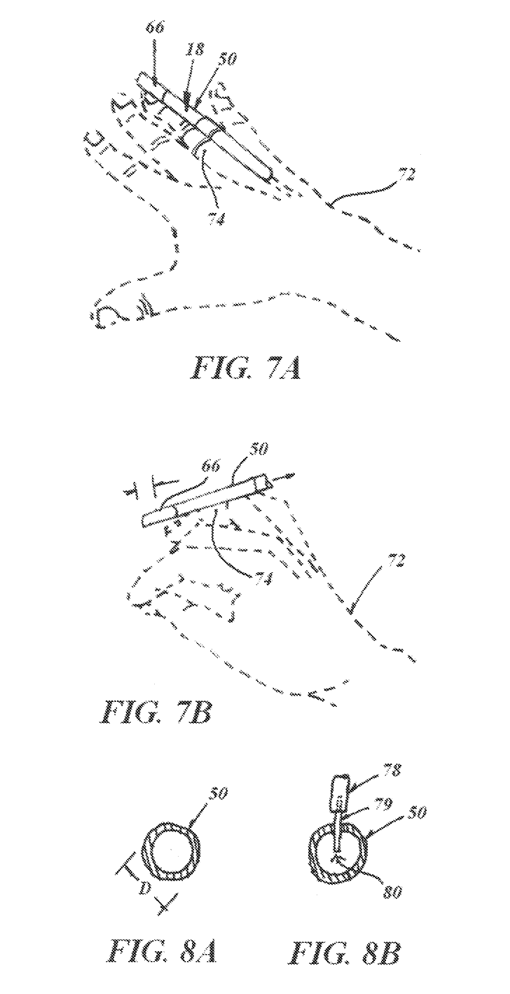

The low-pressure air flow source 14 provides gas (air) at a pressure and flow rate appropriate for use in the vicinity of a person's eyes. A typical air-brush compressor 14a has proved adaptable for this purpose. See for example, U.S. Pat. No. 5,088,903. Alternatively, any other source of low-pressure air at an appropriate flow rate may be adapted by one of skill in the art for practice in the present invention, such as a house air-line or a compressed gas bottle 14b (see FIG. 6), or any other device that may serve as an appropriate supply or reservoir of low-pressure air. additionally, the air lines 46 of the present invention may be accomplished using such air delivery lines as typical of an air brush apparatus.

A remote control unit 20 is in communication with the air flow source 14. The remote control unit 20 is a mechanism which controls the flow of air passing or supplied from the air flow source 14 to the output air-line 46. In FIG. 1, the flow of air is controlled via the remote control unit 20, which in turn operates an air flow valve, which preferably is a normally closed air flow valve. In this embodiment, the remote control unit 20 comprised a foot pedal 24, which includes an electrical connection 26 to the air flow source 14a. The foot pedal 24 included an electrical circuit that operated the air flow valve (not shown) inside the electrical compressor type air flow source 14a. In an alternative embodiment, the electrical connection 26 could be a wireless electrical connection.

In the embodiment illustrated in FIG. 6, the foot pedal 24a is disposed inline with the output air-line 46, and in direct gas flow communication with the air flow source 14b and the air dispenser 18. In FIG. 6, the foot pedal 24a of the remote control unit 20a controls the output air flow valve via the operation of a graduated foot-pressure switch, both of which are inside the foot pedal 24a. Graduated switches suitable for practice in the foot pedal 24a are known to and selectable by one of ordinary skill in the art, in view of the teachings herein.

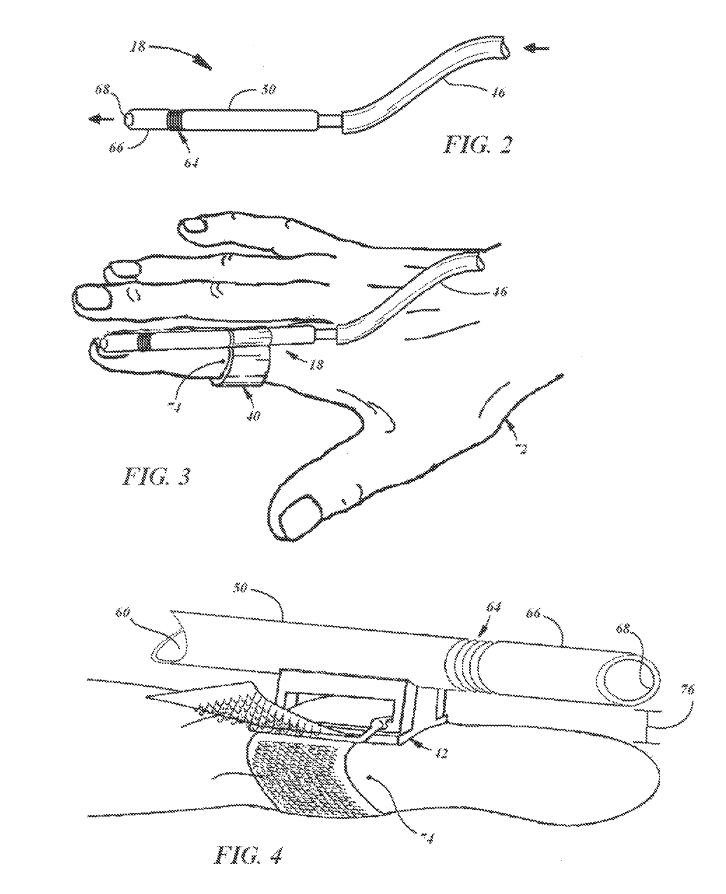

FIGS. 2 and 3 illustrate a preferred embodiment of the air dispenser unit 18 of the present low-pressure air source 10. The air dispenser 18 has a barrel portion 50 having a first gas input end 54 and a nozzle joint end 56. The input end 54 has a gas port 58 that is connectable in gas flow communication to the output air-line 46. The nozzle joint end 56 of the barrel 50 terminates in a ported swivel or pivot joint 64. A gas flow passage 60 connects the gas port 58 with the ported joint 64 in gas flow communication. The pivot joint 64 connects the nozzle joint end 56 of the barrel 50 to the nozzle fitting 66 of the air dispenser 18. The pivot joint 64 in the embodiment illustrated is a “crinkled” or “accordioned” section of the tube that forms the barrel 50 and/or nozzle fitting 66, and functions as a pivot much as the similar crinkled section of a common soda straw. The nozzle fitting 66 has a nozzle gas chamber 62 in gas flow communication with the gas flow passage of the barrel 50. The nozzle gas chamber 62 of the nozzle fitting 66 terminates in a gas outflow port 68. The air flow from the outflow port 68 is “directable” in that the air nozzle fitting 66 of the air dispenser 18 may be variably pivoted relative to the barrel 50 of the air dispenser 18 to alter the direction of the air flow expelled from the nozzle orifice 68 of the air nozzle 66.

In FIG. 6, the input gas port 58 of the air dispenser 18 is connected to an air line 46a that is in direct flow communication with the output of a graduated, pressure operated gas valve (not shown) in the foot pedal 24a of the remote control unit 20a. The input gas port of the graduated pressure operated gas valve in the foot pedal 24a is in direct flow communication with the bottle output valve (not shown) of a bottle-type gas pressure reservoir 14a.

In the preferred embodiments shown, the barrel 50 of the air dispenser 18 comprises a hollow cylindrical tube that attaches to a finger of the beautician's hand, typically the index finger. The barrel 50 of the air dispenser 18 is attached to the beautician's finger by any of a number of mounting means known to and selectable by one of ordinary skill in the art for practice in the present invention. For example, In FIG. 3, the mounting means is a finger ring mount 40, and in FIG. 4, the mounting means comprises a finger strap mount 42. As a further example, the barrel 50 may be mounted to the finger of a glove, which the beauty practitioner wears. The mounting means holds the barrel 50 of the air dispenser 18 in a relatively stable relationship to the finger joint 74 of the practitioner's hand 72 to which it is attached. This allows the practitioner to move the hand 72 without having drag from the mass of the airline 46 altering the relationship of the barrel 50 to the finger joint of the practitioner. Typically, this relationship will be that the line of the gas flow passage 60 of the barrel 50 will be in line with the bone of the finger joint 74.

In the embodiment illustrated, the exterior diameter D of the barrel 50 is not larger than the width of the finger joint 74 on which it is mounted, see FIG. 8A. In the embodiments illustrated, mounting the air dispenser 18 to the beautician's finger is accomplished using a wide band finger ring 40, and alternatively using a hook-and-loop strap mount 42 snuggly wrapped around the finger joint 74. A portion of the airline 60 may be attached to another finger joint or to the hand or wrist of the practitioner to reduce or eliminate the possibility that the airline 60 will drag on the air dispenser 18 during movement of the practitioner's hand 72. However the attachment is accomplished, mounting of the air dispenser 18 on the practitioner's finger should not interfere with his/her ability to bend the finger nor otherwise hamper the practitioner's dexterity.

The barrel 50 portion of the air dispenser 18 typically will be at least semi-rigid in view of its intended use and alignment with the finger joint. The material composition of the barrel 50 should allow it to facilitate accurate directional control of the air flow by the practitioner pointing the finger to which it is mounted. The nozzle fitting 66 preferably should be soft to the touch (or covered with a soft material) in view of its use proximate a subject's eye. An acceptable material for this purpose is a foam rubber. However, the nozzle fitting 66 must be rigid enough to maintain directional control of the air flow. The final positioning of the barrel mount 40 on the finger; the air dispenser 18 onto the mount 40; and the air flow port 68 of the nozzle fitting 66 are adjustable by the beautician/practitioner to satisfy his/her individual dexterity and comfort. For example, there can be a gap 76 between the end of the practitioner's finger and the air flow port 68 of the nozzle fitting 66, such that the tip of the air flow port 68 extends beyond the user's finger tip. The purpose of the gap 76 is to limit any interference in the air flow by the practitioner's finger tip. A typical gap 76 can be one-quarter to one-half inch.

In use of the preferred embodiments of the assembled remotely controlled, hands-free, low-pressure air source 10, the air source 14 provides an appropriate stream of air flow at the nozzle port 68 of the air dispenser 18. Control of the air flow is accomplished using the remote control unit 20. The control units 20 illustrated comprise a foot pedal operated by the practitioner's foot. Use of the foot pedal control unit 20 enables the hands-free operation of the present remotely controlled, hands-free, low-pressure air source 10. The air flow switch/valve (not shown) is normally biased in the off/closed position, so that removing the foot pressure from the control unit 20 turns off the flow of air. Also, in a preferred embodiment, the pressure switch/valve is not just an on-off valve, but is adapted so that increasing the pressure on the switch causes a corresponding increase in the pressure and air flow from the nozzle port 68 (see FIG. 6).

As shown in FIG. 8B, additives 80 can be introduced to the air flow within the barrel 50 of the air dispenser 18, by utilizing an optional venturi tube 78 inserted into a venturi port 79 on the barrel 50, much as might be found on an air brush dispenser unit. Such additives 80 may include water, as water decreases the curing time of certain adhesive compositions. Another additive may be an oil-based sealant, which seals the lash extensions to reduce staining or discoloration.

To use the present remotely controlled, hands-free, low-pressure air source 10, a practitioner attaches the barrel 50 of the air dispenser 18 to a finger joint 74, of the dispenser mounted hand 72 as illustrated herein. The air lines 46 are used to connect the air dispenser 18 to the air source 14. The portion of the air line 46 proximate the air dispenser 18 may attached to the wearer's wrist to prevent interference of the air line 46 with the wearer's hand operations. Air flow is adjusted to provide light air pressure at the nozzle port 68 of the nozzle fitting 66.

Then, the index finger and thumb of the wearer's dispenser mounted hand 72 are able to grasp a forcipes or other instrument as may be used in the lash extension process. Air flow from the nozzle fitting 66 is directed by the wearer's finger lengthwise down or along the subject's natural eyelashes. The air flow separates the individual natural eyelashes from each other. Using a forcipes held in the other hand, the practitioner isolates an individual natural lash, and pinches and holds it (preferably against a support patch designed for this purpose). Using the dispenser mounted hand 72, the practitioner picks up an artificial lash extension and dips the base end of the lash extension into a drop of glue (previously placed on the back of the other hand) and wets the base end of the lash extension with the adhesive. The practitioner then applies the lash extension to the isolated individual natural eyelash. Once the adhesive initially sets, the practitioner directs a stream of air over the adhesive to accelerate further setting of the glue and to advance curing of the adhesive. Accelerating the setting and curing of the adhesive decreases the amount of time required to apply a single lash extension to a natural eyelash hair of the subject, and substantially reduces the amount of time required for the application of a complete set of artificial lash extensions.

A further benefit of using the present invention is that a procedurally smooth and continuous application of lash extension can occur because the beautician/practitioner can operate without having to set down the instruments or to change the hands holding the instruments just to use the an air source. The smooth and continuous application of the lash extensions significantly decreases the time required for applying a complete set of single artificial lash extensions to a subject's individual natural eyelashes.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A hands-free directable low-pressure air source for cosmetology use comprising:
a low-pressure air flow source;
a remote control unit in flow communication with the air flow source an adapted to control a flow of air supplied by the air flow source and passing through an air flow valve; and
an air dispenser unit in flow communication with the air passing through the air flow valve, the air dispenser unit having a nozzle to emitting a flow of air passing through the dispenser unit.
